(19) United States
(12) Patent Application Publication
(10) Pub. No.: US 2023/0284328 A1
(43) Pub. Date: Sep. 7, 2023

(54) ENERGY SAVING COORDINATION IN A NETWORK

(71) Applicant: QUALCOMM Incorporated, San Diego, CA (US)

(72) Inventors: Naeem AKL, Somerville, NJ (US); Navid ABEDINI, Basking Ridge, NJ (US); Karl Georg HAMPEL, Jersey City, NJ (US); Junyi LI, Fairless Hills, PA (US); Tao LUO, San Diego, CA (US)

(21) Appl. No.: 17/653,417

(22) Filed: Mar. 3, 2022

(51) Int. Cl. H04W 76/27; H04W 28/02; H04W 28/10; H04W 52/02

(52) U.S. Cl. CPC H04W 76/27; H04W 28/0252; H04W 28/10; H04W 52/0209

(57) ABSTRACT

Various aspects of the present disclosure generally relate to wireless communication. In some aspects, a distributed unit may transmit, to a central unit of the distributed unit, a configuration update including a request to change an activation status of a cell of the distributed unit. The distributed unit may receive, from the central unit, a configuration update acknowledgement based at least in part on transmitting the configuration update including the request to change the activation status of the cell of the distributed unit. Numerous other aspects are provided.

### FIELD OF THE DISCLOSURE

Aspects of the present disclosure generally relate to wireless communication and specifically, to techniques and apparatuses for energy saving coordination in a network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipment (UEs) to communicate on a municipal, national, regional, or global level. New Radio (NR), which may be referred to as 5G, is a set of enhancements to the LIE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In a multi-hop network, a central unit (CU) may communicate with a set of distributed units (DUs), each of which may provide a set of cells. Each cell may be associated with a state. For example, a cell may be associated with an inactive state or an active state. In the inactive state, the CU and DU store a cell context, but the cell does not provide communication services to any UEs. In the active state, the CU and the DU store a cell context and the cell can provide communication services to one or more UEs. The CU may select in which state the cell is to operate. A cell may also be associated with a service status, which may correspond to a state of an over-the-air (OTA) radio transmission by the cell. The DU may report the service status to the CU for active cells, but not for inactive cells. A cell with an “in-service” service status may be operational and capable of serving UEs. A cell with an “out-of-service” service status may not be operational and may be unable to service UEs. The out-of-service service status may occur when, for example, a DU is attempting to make a cell operational but has not completed making the cell operational, such as when the DU is attempting to set up the cell. If a DU fails to make a cell operational, the DU may delete the cell and report deletion of the cell to the CU. When a cell is deleted, the CU deletes the cell context. However, the DU may not be able to deactivate a cell, which may be desirable for energy saving, without deleting the cell, which may result in excessive network overhead to convey a new cell context when the cell is to be reactivated.

Further, when a CU requests to setup a context for a UE at a DU, the DU may not be able to fulfill the request as a result of being in an energy saving mode. The CU may lack information regarding the energy saving mode, and may determine that the DU generally cannot support the UE. However, it may be desirable to allow the CU the override the energy saving mode for some services or to take other actions when the DU is in an energy saving mode (actions that are different from actions the CU might take if the DU generally cannot support the UE as a result of congestion or link conditions, among other examples). This may result in the DU continuing to operate in the energy saving mode even when a high priority service is to be established for the UE. Further, this may result in the CU performing actions associated with congestion or poor link conditions, such as changing beam parameters, activating other DUs, or rejecting services, which are inappropriate for situations where a DU is unavailable as a result of operating in an energy saving mode.

### SUMMARY

Some aspects described herein relate to a method of wireless communication performed by a distributed unit. The method may include transmitting, to a central unit of the distributed unit, a configuration update including a request to change an activation status of a cell of the distributed unit. The method may include receiving, from the central unit, a configuration update acknowledgement based at least in part on transmitting the configuration update including the request to change the activation status of the cell of the distributed unit.

Some aspects described herein relate to a method of wireless communication performed by a distributed unit. The method may include receiving, from a central unit, a request for a change to a service associated with the distributed unit. The method may include transmitting, to the central unit, a response message indicating a rejection of the change to the service, wherein the response message includes information identifying a cause of the rejection of the change of service.

Some aspects described herein relate to a method of wireless communication performed by a central unit. The method may include receiving, from a distributed unit of the central unit, a configuration update including a request to change an activation status of a cell of the distributed unit. The method may include transmitting, to the distributed unit, a configuration update acknowledgement based at least in part on transmitting the configuration update including the request to change the activation status of the cell of the distributed unit.

Some aspects described herein relate to a method of wireless communication performed by a central unit. The method may include transmitting, to a distributed unit, a request for a change to a service associated with the distributed unit. The method may include receiving, from the distributed unit, a response message indicating a rejection of the change to the service, wherein the response message includes information identifying a cause of the rejection of the change of service.

Some aspects described herein relate to a distributed unit for wireless communication. The distributed unit may include at least one processor and at least one memory, communicatively coupled with the at least one processor, that stores processor-readable code. The processor-readable code, when executed by the at least one processor, may be configured to cause the distributed unit to transmit, to a central unit of the distributed unit, a configuration update including a request to change an activation status of a cell of the distributed unit. The processor-readable code, when executed by the at least one processor, may be configured to cause the distributed unit to receive, from the central unit, a configuration update acknowledgement based at least in part on transmitting the configuration update including the request to change the activation status of the cell of the distributed unit.

Some aspects described herein relate to a distributed unit for wireless communication. The distributed unit may include at least one processor and at least one memory, communicatively coupled with the at least one processor, that stores processor-readable code. The processor-readable code, when executed by the at least one processor, may be configured to cause the distributed unit to receive, from a central unit, a request for a change to a service associated with the distributed unit. The processor-readable code, when executed by the at least one processor, may be configured to cause the distributed unit to transmit, to the central unit, a response message indicating a rejection of the change to the service, wherein the response message includes information identifying a cause of the rejection of the change of service.

Some aspects described herein relate to a central unit for wireless communication. The central unit may include at least one processor and at least one memory, communicatively coupled with the at least one processor, that stores processor-readable code. The processor-readable code, when executed by the at least one processor, may be configured to cause the central unit to receive, from a distributed unit of the central unit, a configuration update including a request to change an activation status of a cell of the distributed unit. The processor-readable code, when executed by the at least one processor, may be configured to cause the central unit to transmit, to the distributed unit, a configuration update acknowledgement based at least in part on transmitting the configuration update including the request to change the activation status of the cell of the distributed unit.

Some aspects described herein relate to a central unit for wireless communication. The central unit may include at least one processor and at least one memory, communicatively coupled with the at least one processor, that stores processor-readable code. The processor-readable code, when executed by the at least one processor, may be configured to cause the central unit to transmit, to a distributed unit, a request for a change to a service associated with the distributed unit. The processor-readable code, when executed by the at least one processor, may be configured to cause the central unit to receive, from the distributed unit, a response message indicating a rejection of the change to the service, wherein the response message includes information identifying a cause of the rejection of the change of service.

Some aspects described herein relate to a non-transitory computer-readable medium that stores a set of instructions for wireless communication by a distributed unit. The set of instructions, when executed by one or more processors of the distributed unit, may cause the distributed unit to transmit, to a central unit of the distributed unit, a configuration update including a request to change an activation status of a cell of the distributed unit. The set of instructions, when executed by one or more processors of the distributed unit, may cause the distributed unit to receive, from the central unit, a configuration update acknowledgement based at least in part on transmitting the configuration update including the request to change the activation status of the cell of the distributed unit.

Some aspects described herein relate to a non-transitory computer-readable medium that stores a set of instructions for wireless communication by a distributed unit. The set of instructions, when executed by one or more processors of the distributed unit, may cause the distributed unit to receive, from a central unit, a request for a change to a service associated with the distributed unit. The set of instructions, when executed by one or more processors of the distributed unit, may cause the distributed unit to transmit, to the central unit, a response message indicating a rejection of the change to the service, wherein the response message includes information identifying a cause of the rejection of the change of service.

Some aspects described herein relate to a non-transitory computer-readable medium that stores a set of instructions for wireless communication by a central unit. The set of instructions, when executed by one or more processors of the central unit, may cause the central unit to receive, from a distributed unit of the central unit, a configuration update including a request to change an activation status of a cell of the distributed unit. The set of instructions, when executed by one or more processors of the central unit, may cause the central unit to transmit, to the distributed unit, a configuration update acknowledgement based at least in part on transmitting the configuration update including the request to change the activation status of the cell of the distributed unit.

Some aspects described herein relate to a non-transitory computer-readable medium that stores a set of instructions for wireless communication by a central unit. The set of instructions, when executed by one or more processors of the central unit, may cause the central unit to transmit, to a distributed unit, a request for a change to a service associated with the distributed unit. The set of instructions, when executed by one or more processors of the central unit, may cause the central unit to receive, from the distributed unit, a response message indicating a rejection of the change to the service, wherein the response message includes information identifying a cause of the rejection of the change of service.

Some aspects described herein relate to an apparatus for wireless communication. The apparatus may include means for transmitting, to a central unit of the apparatus, a configuration update including a request to change an activation status of a cell of the apparatus. The apparatus may include means for receiving, from the central unit, a configuration update acknowledgement based at least in part on transmitting the configuration update including the request to change the activation status of the cell of the apparatus.

Some aspects described herein relate to an apparatus for wireless communication. The apparatus may include means for receiving, from a central unit, a request for a change to a service associated with the apparatus. The apparatus may include means for transmitting, to the central unit, a response message indicating a rejection of the change to the service, wherein the response message includes information identifying a cause of the rejection of the change of service.

Some aspects described herein relate to an apparatus for wireless communication. The apparatus may include means for receiving, from a distributed unit of the apparatus, a configuration update including a request to change an activation status of a cell of the distributed unit. The apparatus may include means for transmitting, to the distributed unit, a configuration update acknowledgement based at least in part on transmitting the configuration update including the request to change the activation status of the cell of the distributed unit.

Some aspects described herein relate to an apparatus for wireless communication. The apparatus may include means for transmitting, to a distributed unit, a request for a change to a service associated with the distributed unit. The apparatus may include means for receiving, from the distributed unit, a response message indicating a rejection of the change to the service, wherein the response message includes information identifying a cause of the rejection of the change of service.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example base station in communication with a user equipment (UE) in a wireless network, in accordance with the present disclosure.

FIG. 3 is a diagram illustrating an example of a disaggregated base station architecture, in accordance with the present disclosure.

FIGS. 4-5 are diagrams illustrating examples associated with energy saving coordination in a network, in accordance with the present disclosure.

FIGS. 6-7 are flowcharts illustrating example processes performed, for example, by a distributed unit (DU) that supports energy saving coordination, in accordance with the present disclosure.

FIGS. 8-9 are flowcharts illustrating example processes performed, for example, by a central unit (CU) that supports energy saving coordination, in accordance with the present disclosure.

FIGS. 10-11 are diagrams of example apparatuses for wireless communication that support energy saving coordination, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to energy saving coordination in a network. Some aspects more specifically relate to enabling a distributed unit (DU) to initiate activation or deactivation of a cell by transmitting, to a central unit (CU), a configuration update message, such as a gNB-DU configuration update message or a gNB-CU configuration update acknowledgement message. The DU may deactivate a cell when the DU is in an energy saving mode or is attempting to transition to an energy saving mode. Based at least in part on the DU initiating deactivation of a cell, the CU can store a context while the DU is in the energy saving mode. Further, by providing a signaling path for activation of the cell, the DU can activate the cell after the DU exits the energy saving mode or when the DU is attempting to transition out of the energy saving mode. In some aspects, a CU may request to setup a context for a UE at a DU that is in an energy saving mode and the DU may reject the request to setup the context while the DU is using the energy saving mode. In such an example, the DU may provide information indicating that the request is rejected because the DU is operating in the energy saving mode rather than as a result of congestion or link conditions.

Particular aspects of the subject matter described in this disclosure can be implemented to realize one or more of the following potential advantages. In some examples, the described techniques can be used to reduce signaling overhead and usage of energy resources by enabling a CU to store a context of a cell when the cell is deactivated as a result of the DU entering an energy saving mode. In such examples, by enabling the CU to store the context of the cell after a DU-triggered cell deactivation, the CU and the DU do not need to communicate to provide the CU with the context of the cell when the cell is reactivated, thereby reducing signaling overhead and usage of energy resources. In some other examples, the described techniques can be used to improve CU control of a network by enabling the CU to use information regarding the DU's usage of the energy saving mode. In other words, when a DU cannot fulfill a request for service, the CU may perform first actions when the rejection of the request is a result of congestion or link conditions and second actions when the rejection of the request is a result of the DU in an energy saving mode.

In such examples, by the DU providing information indicating why the DU is rejecting the request, the DU enables the CU to select actions appropriate to the rejection of the request, which improves control of the network. For example, when the DU is rejecting the request as a result of congestion, the CU may cause a handover for a UE or may throttle traffic toward a DU serving the UE. Further, when the CU receives an indication that the congestion has been reduced, the CU may resume non-throttled operation of the DU. During an energy saving mode, network traffic levels may be relatively low, so throttling network traffic may not have a significant effect. In contrast, when the rejection is related to the energy saving mode, the CU may deactivate a cell. If the CU deactivated a cell when the rejection was a result of network congestion, UEs associated with the cell will enter a radio link failure (RLF) state, which may cause further congestion on other cells.

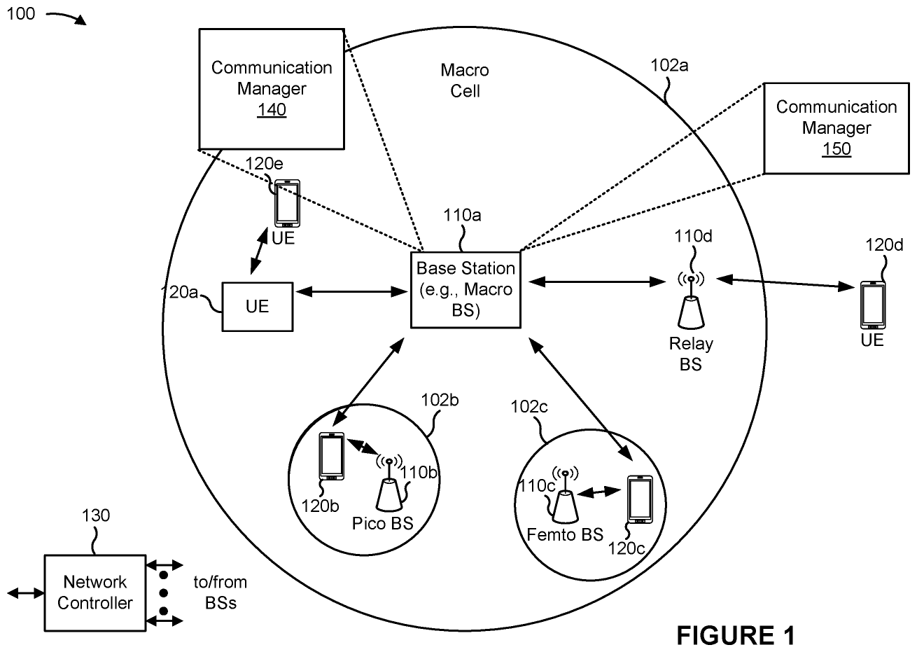

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a base station (BS) 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LIE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a distributed unit (which may correspond to one or more components of base station 110 or which may include base station 110) may include a communication manager 140. As described in more detail elsewhere herein, the communication manager 140 may transmit, to a central unit of the distributed unit, a configuration update including a request to change an activation status of a cell of the distributed unit; and receive, from the central unit, a configuration update acknowledgement based at least in part on transmitting the configuration update including the request to change the activation status of the cell of the distributed unit. Additionally or alternatively, the communication manager 140 may perform one or more other operations described herein.

In some aspects, as described in more detail elsewhere herein, the communication manager 140 may receive, from a central unit, a request for a change to a service associated with the distributed unit; and transmit, to the central unit, a response message indicating a rejection of the change to the service, wherein the response message includes information identifying a cause of the rejection of the change of service. Additionally or alternatively, the communication manager 140 may perform one or more other operations described herein.

In some aspects, a central unit (which may correspond to one or more components of base station 110 or which may include base station 110) may include a communication manager 150. As described in more detail elsewhere herein, the communication manager 150 may receive, from a distributed unit of the central unit, a configuration update including a request to change an activation status of a cell of the distributed unit; and transmit, to the distributed unit, a configuration update acknowledgement based at least in part on transmitting the configuration update including the request to change the activation status of the cell of the distributed unit. Additionally or alternatively, the communication manager 150 may perform one or more other operations described herein.

In some aspects, as described in more detail elsewhere herein, the communication manager 150 may transmit, to a distributed unit, a request for a change to a service associated with the distributed unit; and receive, from the distributed unit, a response message indicating a rejection of the change to the service, wherein the response message includes information identifying a cause of the rejection of the change of service. Additionally or alternatively, the communication manager 150 may perform one or more other operations described herein.

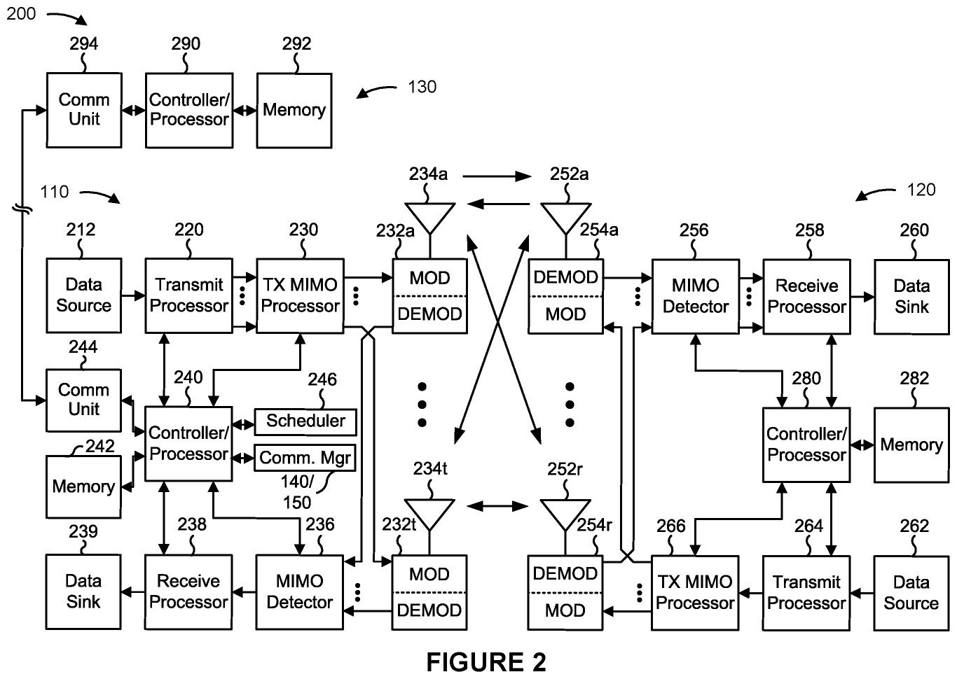

FIG. 2 is a diagram illustrating an example 200 of a base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

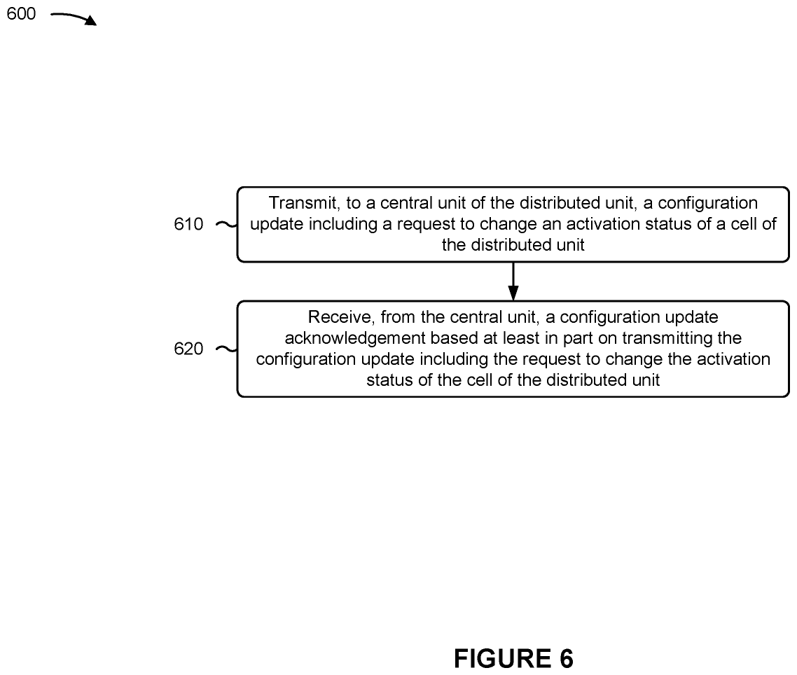

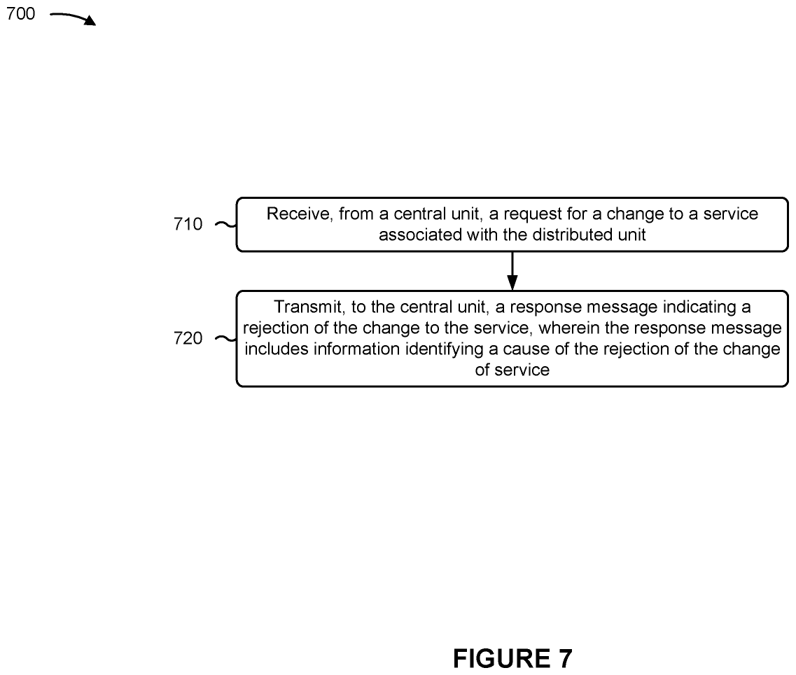

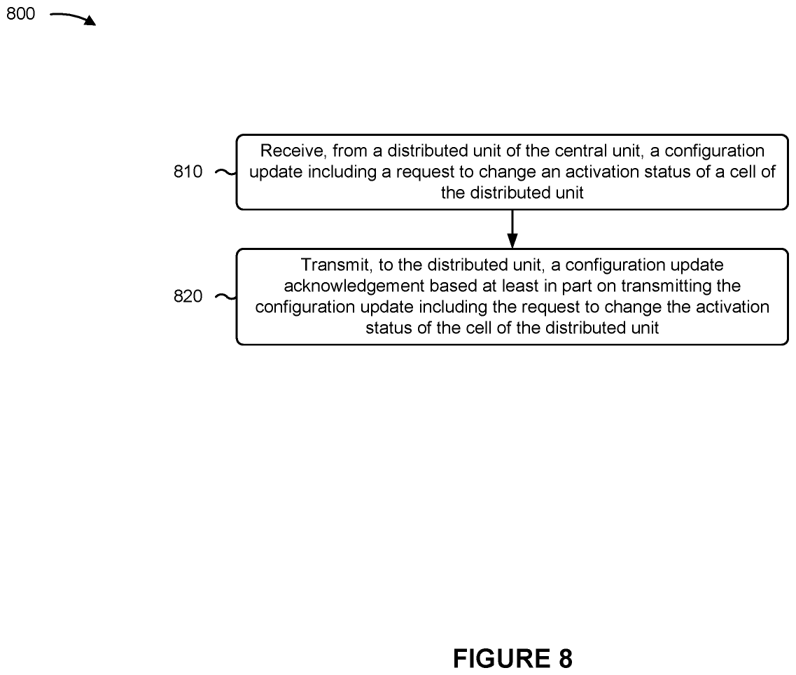

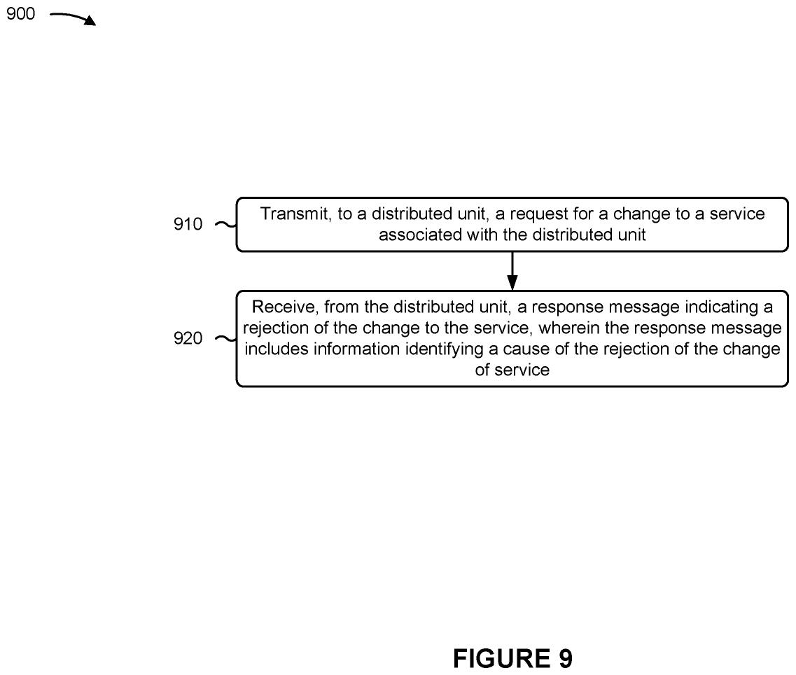

The controller/processor 240 of the base station 110, the controller/processor 280 of the UE 120, or any other component(s) of FIG. 2 may perform one or more techniques associated with energy saving coordination in a network, as described in more detail elsewhere herein. In some aspects, the distributed unit or central unit described herein is the base station 110, is included in the base station 110, or includes one or more components of the base station 110 shown in FIG. 2. For example, the controller/processor 240 of the base station 110, the controller/processor 280 of the UE 120, or any other component(s) of FIG. 2 may perform or direct operations of, for example, process 600 of FIG. 6, process 700 of FIG. 7, process 800 of FIG. 8, process 900 of FIG. 9, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, or interpreting the instructions, among other examples.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, that is, a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

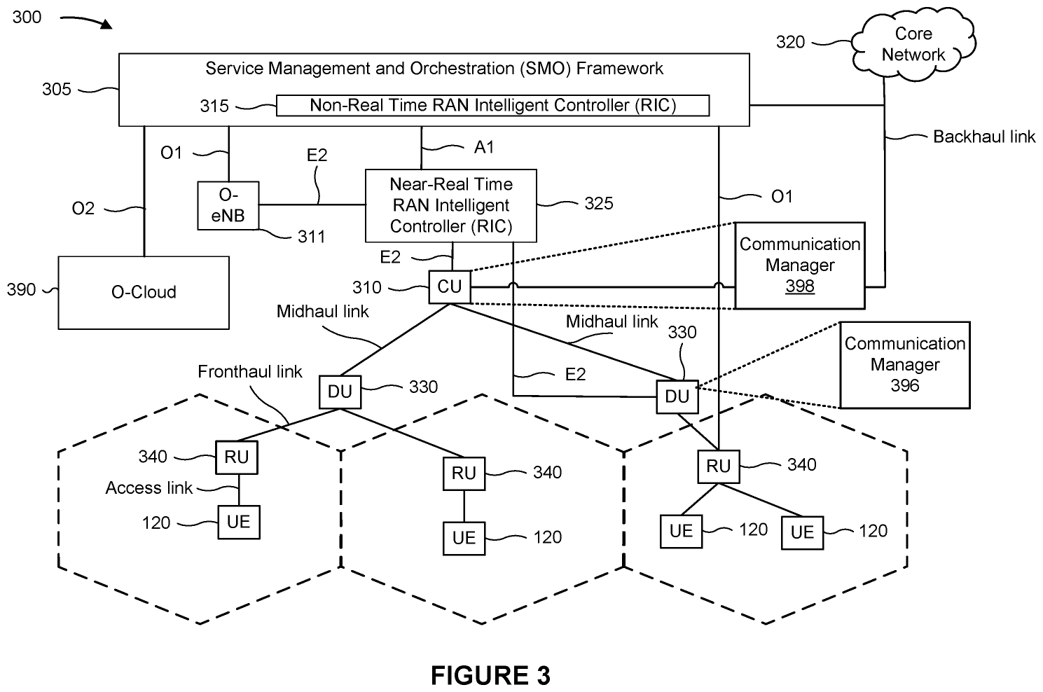

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (RT) (Near-RT) RAN Intelligent Controller (RIC) 325 via an E2 link, or a Non-Real Time (Non-RT) RIC 315 associated with a Service Management and Orchestration (SMO) Framework 305, or both). A CU 310, which may include a communication manager 398 (which may correspond to communication manager 150), may communicate with one or more distributed units (DUs) 330, which may include respective communication managers 396 (which may correspond to communication managers 140), via respective midhaul links, such as an F1 interface. The DUs 330 may communicate with one or more radio units (RUs) 340 via respective fronthaul links The RUs 340 may communicate with respective UEs 120 via one or more radio frequency (RF) access links In some implementations, the UE 120 may be simultaneously served by multiple RUs 340.

Each of the units, that is, the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), or service data adaptation protocol (SDAP), among other examples. Each control function can be implemented with an interface configured to communicate signals with other control functions hosted by the CU 310. The CU 310 may be configured to handle user plane functionality (Central Unit-User Plane (CU-UP)), control plane functionality (Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, or modulation and demodulation, among other examples) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, or physical random access channel (PRACH) extraction and filtering, among other examples), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

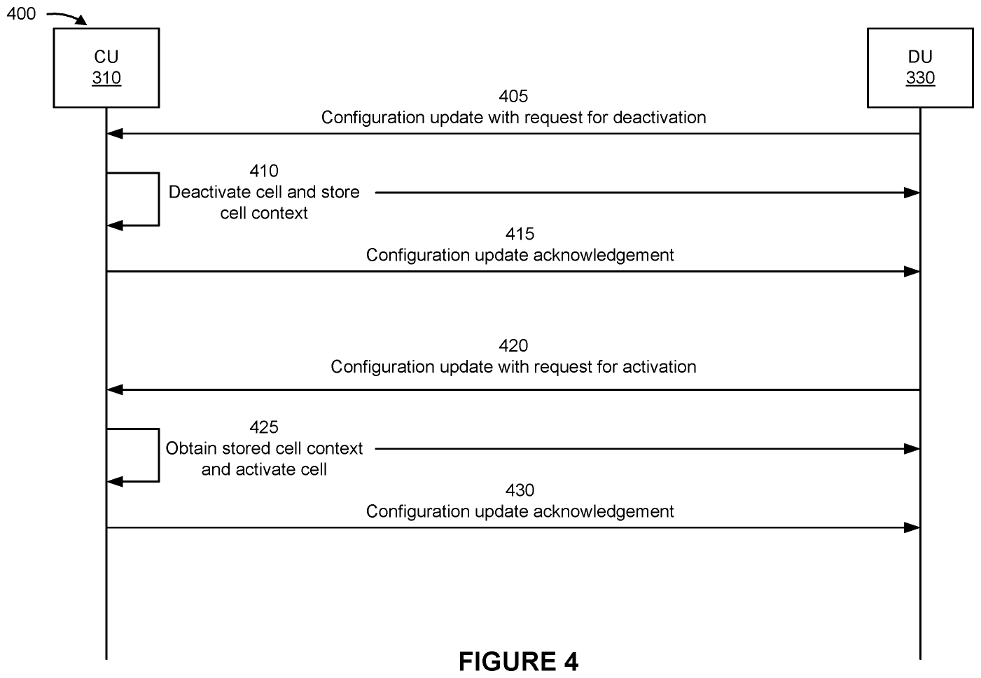

FIG. 4 is a diagram illustrating an example 400 associated with energy saving coordination in a network, in accordance with the present disclosure. As shown in FIG. 4, a CU 310 and a DU 330 may communicate with one another.

In a first operation 405 and a second operation 410, DU 330 may transmit, to CU 310, a configuration update with a request to deactivate a cell of the DU 330 and the CU 310 may deactivate the cell and store a cell context for the cell. For example, DU 330 may transmit a configuration update message, such as a gNB-DU configuration update. In some aspects, the CU 310 may transmit a message to instruct DU 330 or another device to deactivate the cell as a response to receiving the request. The configuration update message may include a request to change an activation status of a cell of DU 330, such as to support an energy saving mode that DU 330 is using or into which DU 330 is attempting to transition. In such examples, CU 310 may receive the request, deactivate the cell, and store a cell context of the cell. In other words, rather than deleting the cell context, as occurs when DU 330 transmits a cell deletion request, CU 310 maintains the cell context while the cell is deactivated. In a third operation 415, CU 310 may transmit a configuration update acknowledgement to DU 330. For example, in some aspects, DU 330 may receive a configuration update acknowledgement, such as a gNB-DU configuration update acknowledgement (as a response to a gNB-DU configuration update), indicating that CU 310 received the request to deactivate the cell, has deactivated the cell, or has stored a cell context for the cell. In another example, CU 310 may transmit a gNB-CU configuration update, which may trigger DU 330 to transmit a gNB-CU configuration update acknowledgement. In other words, a request described herein may be transmitted from DU 330 to CU 310, as shown, or may be transmitted from CU 310 to DU 330.

In a fourth operation 420 and a fifth operation 425, DU 330 may transmit, to CU 310, a configuration update with a request to activate the cell of DU 330, and CU 310 may activate the cell using a stored cell context for the cell. For example, DU 330 may transmit a configuration update message, such as a gNB-DU configuration update. The configuration update message may include a request to change an activation status of a cell of DU 330, such as when DU 330 has stopped in an energy saving mode or is attempting to transition out of using the energy saving mode. Additional details regarding states of a cell, such as an inactivate state associated with energy saving, are described with regard to 3GPP Technical Specification (TS) 38.401, Release 16, Version 16.8.0, section 8.5. In such examples, CU 310 may receive the request, obtain a stored cell context of the cell, and activate the cell. Similarly, DU 330 may add the cell back to a set of activated cells in connection with transmitting the request to activate the cell. In other words, rather than communicating to convey a new cell context, as occurs when DU 330 transmits a cell addition request, CU 310 uses the stored cell context. In a sixth operation 430, CU 310 may transmit a configuration update acknowledgement to DU 330. For example, in some aspects, DU 330 may receive a configuration update acknowledgement indicating that CU 310 received the request to activate the cell and has activated cell using a stored cell context.

In some aspects, DU 330 may indicate when the period of time is to elapse. For example, DU 330 may transmit an indication that DU 330 will deactivate a cell after a particular interval of time, quantity of slots, or occurrence of a triggering event, among other examples. Additionally or alternatively, DU 330 may transmit an indication of an interval after which DU 330 will fulfill or will resume fulfilling an instruction to activate or deactivate a cell, as described in more detail herein.

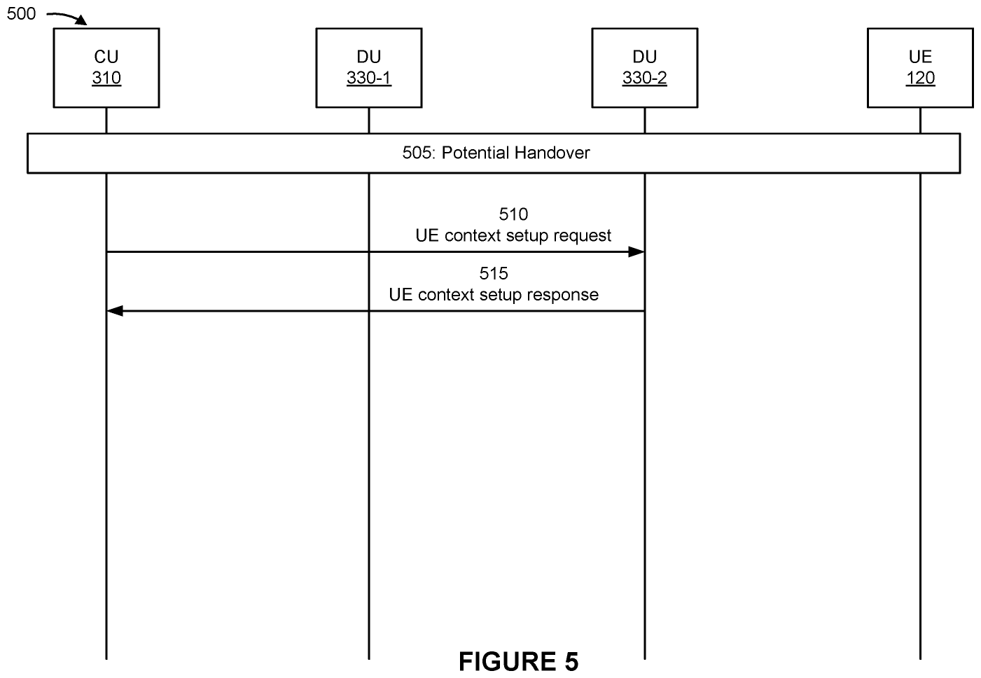

FIG. 5 is a diagram illustrating an example 500 associated with energy saving coordination in a network, in accordance with the present disclosure. As shown in FIG. 5, a CU 310, a first DU 330-1, a second DU 330-2, and a UE 120 may communicate with one another. In some aspects, initially, the UE 120 may be connected to the first DU 330-1. In a first operation 505, CU 310 may communicate with first DU 330-1 or UE 120 to initiate a handover procedure to attempt to handover UE 120 from first DU 330-1 to second DU 330-2.

In a second operation 510, CU 310 may transmit a UE context setup or modification request to second DU 330-2. For example, CU 310 may transmit the UE context setup request to trigger second DU 330-2 to setup service and enable second DU 330-2 to provide service to UE 120 after a handover from first DU 330-1. In such examples, the service may include a communication service, setup or modification of a radio bearer, setup or modification of a backhaul (BH) radio link control (RLC) channel (CH), setup or modification of a secondary cell (SCell), among other examples. In some aspects, the service may be associated with a network entity that communicates with or is in communication with CU 310 via second DU 330-2, such as a UE 120 or another type of node.

In some aspects, CU 310 may transmit configuration information associated with the UE context setup request. For example, CU 310 may transmit an indication of a set of services that CU 310 may request that second DU 330-2 establish. In such examples, CU 310 may indicate one or more services for which second DU 330-2 may reject establishment, as described below, and one or more services for which second DU 330-2 may not reject establishment. For example, CU 310 may indicate a list of cells that includes a first cell for which second DU 330-2 may reject setup or configuration and includes a second cell for which second DU 330-2 may not reject activation.

In a third operation 515, second DU 330-2 may transmit a UE context setup response message. For example, second DU 330-2 may indicate that second DU 330-2 cannot fulfill the request to establish the service as a result of second DU 330-2 operating in an energy saving mode (rather than as a result of, for example, congestion or link conditions). In some aspects, second DU 330-2 may transmit the UE context setup or modification response message in a context message. For example, second DU 330-2 may transmit the UE context setup response message using a UE context setup/modification failure message, a UE context modification required message, or a UE context release request message. Additionally or alternatively, second DU 330-2 may transmit the UE context setup response message using a failure to setup/modified list message for a sidelink radio bearer (SRB), a data radio bearer (DRB), a backhaul radio link control channel (BH RLC CH), a sidelink DRB, or a secondary cell. In some aspects, second DU 330-2 may use a particular field to indicate a reason for rejecting the UE context setup request. For example, second DU 330-2 may set a cause value in a UE context setup response message to indicate that second DU 330-2 cannot setup the UE context as a result of usage of an energy saving mode.

In some aspects, second DU 330-2 may partially fulfill the UE context setup request. For example, second DU 330-2 may establish a service requested in the UE context setup request for a period of time. In such examples, second DU 330-2 may transmit the UE context setup response message to indicate or request a release of the service after the period of time to maintain the energy saving mode. For example, second DU 330-2 may set a cause value to request deactivation of a cell, release of a context, or modification of a context, among other examples. In some aspects, second DU 330-2 may indicate when the period of time is to elapse. For example, second DU 330-2 may transmit the UE context setup response message to indicate that second DU 330-2 will end a service established to fulfill the UE context setup response message after a particular interval of time, quantity of slots, or occurrence of a triggering event, among other examples. Additionally or alternatively, second DU 330-2 may transmit the UE context setup response message to indicate an interval after which second DU 330-2 will fulfill or will resume fulfilling the UE context setup request. For example, second DU 330-2 may indicate that second DU 330-2 will discontinue the requested service for a period of time associated with the energy saving mode, after which second DU 330-2 will provide the requested service.

FIG. 6 is a flowchart illustrating an example process 600 performed, for example, by a distributed unit in accordance with the present disclosure. Example process 600 is an example where the distributed unit (for example, distributed unit 330) performs operations associated with energy saving coordination in a network.

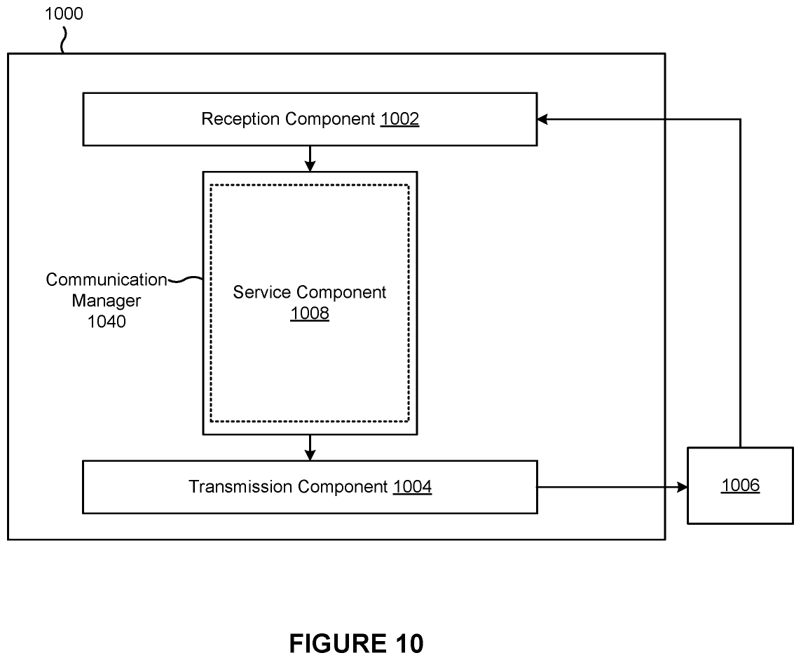

As shown in FIG. 6, in some aspects, process 600 may include transmitting, to a central unit of the distributed unit, a configuration update including a request to change an activation status of a cell of the distributed unit (block 610). For example, the distributed unit (such as by using communication manager 1040 or transmission component 1004, depicted in FIG. 10) may transmit, to a central unit of the distributed unit, a configuration update including a request to change an activation status of a cell of the distributed unit, as described above.

As further shown in FIG. 6, in some aspects, process 600 may include receiving, from the central unit, a configuration update acknowledgement based at least in part on transmitting the configuration update including the request to change the activation status of the cell of the distributed unit (block 620). For example, the distributed unit (such as by using communication manager 1040 or reception component 1002, depicted in FIG. 10) may receive, from the central unit, a configuration update acknowledgement based at least in part on transmitting the configuration update including the request to change the activation status of the cell of the distributed unit, as described above.

Process 600 may include additional aspects, such as any single aspect or any combination of aspects described below or in connection with one or more other processes described elsewhere herein.

In a first additional aspect, the configuration update acknowledgement includes a confirmation of the change to the activation status of the cell of the distributed unit.

In a second additional aspect, alone or in combination with the first additional aspect, the change to the activation status is an activation of the cell of the distributed unit or a deactivation of the cell of the distributed unit.

In a third additional aspect, alone or in combination with one or more of the first and second additional aspects, the change to the activation status is a deactivation of the cell of the distributed unit, and a context of the cell is stored at the central unit based at least in part on the deactivation of the cell of the distributed unit.

In a fourth additional aspect, alone or in combination with one or more of the first through third additional aspects, the change to the activation status is a deactivation of the cell of the distributed unit, and process 600 includes receiving, from the central unit, a request to reactivate the cell of the distributed unit.

In a fifth additional aspect, alone or in combination with one or more of the first through fourth additional aspects, the request to reactivate the cell of the distributed unit occurs after the deactivation of the cell of the distributed unit without an intervening cell addition for the cell of the distributed unit.

FIG. 7 is a flowchart illustrating an example process 700 performed, for example, by a distributed unit in accordance with the present disclosure. Example process 700 is an example where the distributed unit (for example, distributed unit 330) performs operations associated with energy saving coordination in a network.

As shown in FIG. 7, in some aspects, process 700 may include receiving, from a central unit, a request for a change to a service associated with the distributed unit (block 710). For example, the distributed unit (such as by using communication manager 1040 or reception component 1002, depicted in FIG. 10) may receive, from a central unit, a request for a change to a service associated with the distributed unit, as described above.

As further shown in FIG. 7, in some aspects, process 700 may include transmitting, to the central unit, a response message indicating a rejection of the change to the service, wherein the response message includes information identifying a cause of the rejection of the change of service (block 720). For example, the distributed unit (such as by using communication manager 1040 or transmission component 1004, depicted in FIG. 10) may transmit, to the central unit, a response message indicating a rejection of the change to the service, wherein the response message includes information identifying a cause of the rejection of the change of service, as described above.

Process 700 may include additional aspects, such as any single aspect or any combination of aspects described below or in connection with one or more other processes described elsewhere herein.

In a first additional aspect, the cause of the rejection of the change of service is a usage of an energy saving mode.

In a second additional aspect, alone or in combination with the first additional aspect, the response message includes at least one of a UE context setup failure message, a UE context modification failure message, a UE context modification required message, a UE context release required message, or a combination thereof.

In a third additional aspect, alone or in combination with one or more of the first and second additional aspects, the response message includes a failure to be setup or modified list message for at least one of a signal radio bearer, a data radio bearer, a backhaul radio link control channel, a sidelink data radio bearer, a secondary cell, or a combination thereof.

In a fourth additional aspect, alone or in combination with one or more of the first through third additional aspects, an indication of the cause of the rejection of the change of the service is conveyed in a cause value field associated with rejecting the change of the service.

In a fifth additional aspect, alone or in combination with one or more of the first through fourth additional aspects, the change of the service includes at least one of a cell activation, a UE context setup, a channel setup, a channel modification, a context modification for a child of the distributed unit, or a combination thereof.

In a sixth additional aspect, alone or in combination with one or more of the first through fifth additional aspects, the distributed unit is configured to admit the service for which the change of the service is requested, and the response message includes a request for a release of the service.

In a seventh additional aspect, alone or in combination with one or more of the first through sixth additional aspects, the response message includes timing information for a discontinuation or resumption of the service.

In an eighth additional aspect, alone or in combination with one or more of the first through seventh additional aspects, process 700 includes receiving an indication of a set of services for which the distributed unit is enabled to reject requests for changes of services, and transmitting the response message comprises transmitting the response message indicating the rejection of the change of service based at least in part on the service being included in the set of services for which the distributed unit is enabled to reject requests for changes of services.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, by a central unit in accordance with the present disclosure. Example process 800 is an example where the central unit (for example, central unit 310) performs operations associated with energy saving coordination in a network.

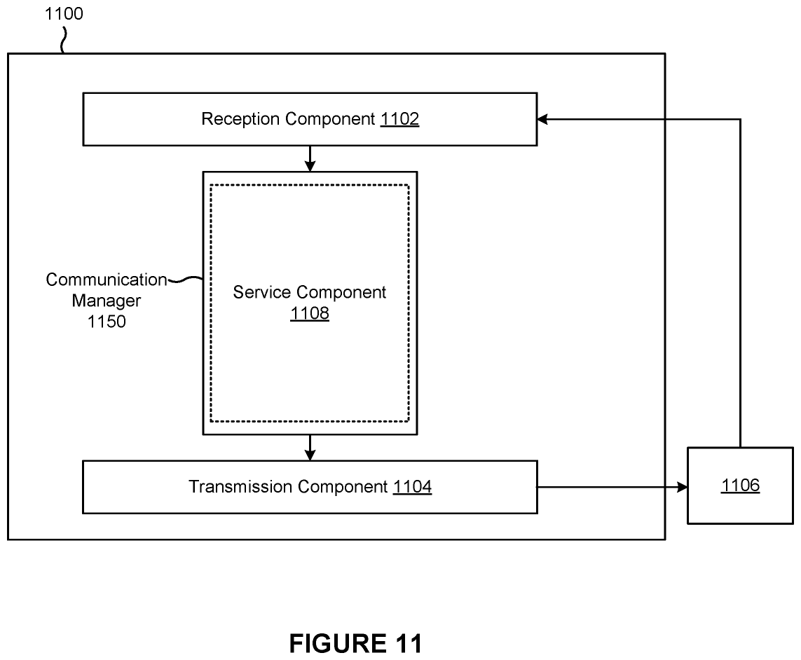

As shown in FIG. 8, in some aspects, process 800 may include receiving, from a distributed unit of the central unit, a configuration update including a request to change an activation status of a cell of the distributed unit (block 810). For example, the central unit (such as by using communication manager 1150 or reception component 1102, depicted in FIG. 11) may receive, from a distributed unit of the central unit, a configuration update including a request to change an activation status of a cell of the distributed unit, as described above.

As further shown in FIG. 8, in some aspects, process 800 may include transmitting, to the distributed unit, a configuration update acknowledgement based at least in part on transmitting the configuration update including the request to change the activation status of the cell of the distributed unit (block 820). For example, the central unit (such as by using communication manager 1150 or transmission component 1104, depicted in FIG. 11) may transmit, to the distributed unit, a configuration update acknowledgement based at least in part on transmitting the configuration update including the request to change the activation status of the cell of the distributed unit, as described above.

Process 800 may include additional aspects, such as any single aspect or any combination of aspects described below or in connection with one or more other processes described elsewhere herein.

In a first additional aspect, the configuration update acknowledgement includes a confirmation of the change to the activation status of the cell of the distributed unit.

In a second additional aspect, alone or in combination with the first additional aspect, the change to the activation status is an activation of the cell of the distributed unit or a deactivation of the cell of the distributed unit.

In a third additional aspect, alone or in combination with one or more of the first and second additional aspects, the change to the activation status is a deactivation of the cell of the distributed unit, and a context of the cell is stored at the central unit based at least in part on the deactivation of the cell of the distributed unit.

In a fourth additional aspect, alone or in combination with one or more of the first through third additional aspects, the change to the activation status is a deactivation of the cell of the distributed unit, and process 800 includes transmitting, to the distributed unit, a request to reactivate the cell of the distributed unit.

In a fifth additional aspect, alone or in combination with one or more of the first through fourth additional aspects, the request to reactivate the cell of the distributed unit occurs after the deactivation of the cell of the distributed unit without an intervening cell addition for the cell of the distributed unit.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, by a central unit in accordance with the present disclosure. Example process 900 is an example where the central unit (for example, central unit 310) performs operations associated with energy saving coordination in a network.

As shown in FIG. 9, in some aspects, process 900 may include transmitting, to a distributed unit, a request for a change to a service associated with the distributed unit (block 910). For example, the central unit (such as by using communication manager 1150 or transmission component 1104, depicted in FIG. 11) may transmit, to a distributed unit, a request for a change to a service associated with the distributed unit, as described above.

As further shown in FIG. 9, in some aspects, process 900 may include receiving, from the distributed unit, a response message indicating a rejection of the change to the service, wherein the response message includes information identifying a cause of the rejection of the change of service (block 920). For example, the central unit (such as by using communication manager 1150 or reception component 1102, depicted in FIG. 11) may receive, from the distributed unit, a response message indicating a rejection of the change to the service, wherein the response message includes information identifying a cause of the rejection of the change of service, as described above.

Process 900 may include additional aspects, such as any single aspect or any combination of aspects described below or in connection with one or more other processes described elsewhere herein.

In a first additional aspect, the cause of the rejection of the change of service is a usage of an energy saving mode.

In a second additional aspect, alone or in combination with the first additional aspect, the response message includes at least one of a UE context setup failure message, a UE context modification failure message, a UE context modification required message, a UE context release required message, or a combination thereof.

In a third additional aspect, alone or in combination with one or more of the first and second additional aspects, the response message includes a failure to be setup or modified list message for at least one of a signal radio bearer, a data radio bearer, a backhaul radio link control channel, a sidelink data radio bearer, a secondary cell, or a combination thereof.

In a fourth additional aspect, alone or in combination with one or more of the first through third additional aspects, an indication of the cause of the rejection of the change of the service is conveyed in a cause value field associated with rejecting the change of the service.

In a fifth additional aspect, alone or in combination with one or more of the first through fourth additional aspects, the change of the service includes at least one of a cell activation, a UE context setup, a channel setup, a channel modification, a context modification for a child of the distributed unit, or a combination thereof.

In a sixth additional aspect, alone or in combination with one or more of the first through fifth additional aspects, the response message includes a request for a release of the service, and further comprising transmitting an instruction to release the service based at least in part on receiving the response message.

In a seventh additional aspect, alone or in combination with one or more of the first through sixth additional aspects, the response message includes timing information for a discontinuation or resumption of the service.

In an eighth additional aspect, alone or in combination with one or more of the first through seventh additional aspects, process 900 includes transmitting an indication of a set of services for which the distributed unit is enabled to reject requests for changes of services, and receiving the response message comprises receiving the response message indicating the rejection of the change of service based at least in part on the service being included in the set of services for which the distributed unit is enabled to reject requests for changes of services.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication in accordance with the present disclosure. The apparatus 1000 may be a DU, or a DU may include the apparatus 1000. In some aspects, the apparatus 1000 includes a reception component 1002, a transmission component 1004, and a communication manager 1040, which may correspond to communication manager 150 or communication manager 396, among other examples, and which may be in communication with one another (for example, via one or more buses). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 4-5. Additionally or alternatively, the apparatus 1000 may be configured to perform one or more processes described herein, such as process 600 of FIG. 6, process 700 of FIG. 7, or a combination thereof. In some aspects, the apparatus 1000 may include one or more components of the DU described above in connection with FIG. 2.

The reception component 1002 may receive communications, such as reference signals, control information, data communications, or a combination thereof, from the apparatus 1006. The reception component 1002 may provide received communications to one or more other components of the apparatus 1000, such as the communication manager 1040. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a modem, a demodulator, a MIMO detector, a receive processor, a controller/processor, a memory, or a combination thereof, of the DU described above in connection with FIG. 2.

The transmission component 1004 may transmit communications, such as reference signals, control information, data communications, or a combination thereof, to the apparatus 1006. In some aspects, the communication manager 1040 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the DU described above in connection with FIG. 2. In some aspects, the transmission component 1004 may be co-located with the reception component 1002 in a transceiver.

The communication manager 1040 may transmit or may cause the transmission component 1004 to transmit, to a central unit of the distributed unit, a configuration update including a request to change an activation status of a cell of the distributed unit. The communication manager 1040 may receive or may cause the reception component 1002 to receive, from the central unit, a configuration update acknowledgement based at least in part on transmitting the configuration update including the request to change the activation status of the cell of the distributed unit. In some aspects, the communication manager 1040 may perform one or more operations described elsewhere herein as being performed by one or more components of the communication manager 1040.

The communication manager 1040 may receive or may cause the reception component 1002 to receive, from a central unit, a request for a change to a service associated with the distributed unit. The communication manager 1040 may transmit or may cause the transmission component 1004 to transmit, to the central unit, a response message indicating a rejection of the change to the service, wherein the response message includes information identifying a cause of the rejection of the change of service. In some aspects, the communication manager 1040 may perform one or more operations described elsewhere herein as being performed by one or more components of the communication manager 1040.

The communication manager 1040 may include a controller/processor, a memory, a scheduler, a communication unit, or a combination thereof, of the DU described above in connection with FIG. 2. In some aspects, the communication manager 1040 includes a set of components, such as a service component 1008. Alternatively, the set of components may be separate and distinct from the communication manager 1040. In some aspects, one or more components of the set of components may include or may be implemented within a controller/processor, a memory, a scheduler, a communication unit, or a combination thereof, of the DU described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1004 may transmit, to a central unit of the distributed unit, a configuration update including a request to change an activation status of a cell of the distributed unit. The reception component 1002 may receive, from the central unit, a configuration update acknowledgement based at least in part on transmitting the configuration update including the request to change the activation status of the cell of the distributed unit.

The reception component 1002 may receive, from a central unit, a request for a change to a service associated with the distributed unit. The transmission component 1004 may transmit, to the central unit, a response message indicating a rejection of the change to the service, wherein the response message includes information identifying a cause of the rejection of the change of service.

The reception component 1002 may receive an indication of a set of services for which the distributed unit is enabled to reject requests for changes of services. The service component 1008 may activate or deactivate a service, such as a cell associated with a UE or other apparatus.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100 for wireless communication in accordance with the present disclosure. The apparatus 1100 may be a CU, or a CU may include the apparatus 1100. In some aspects, the apparatus 1100 includes a reception component 1102, a transmission component 1104, and a communication manager 1150, which may be in communication with one another (for example, via one or more buses). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 4-5. Additionally or alternatively, the apparatus 1100 may be configured to perform one or more processes described herein, such as process 800 of FIG. 8, process 900 of FIG. 9, or a combination thereof. In some aspects, the apparatus 1100 may include one or more components of the CU described above in connection with FIG. 2.

The reception component 1102 may receive communications, such as reference signals, control information, data communications, or a combination thereof, from the apparatus 1106. The reception component 1102 may provide received communications to one or more other components of the apparatus 1100, such as the communication manager 1150. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a modem, a demodulator, a MIMO detector, a receive processor, a controller/processor, a memory, or a combination thereof, of the CU described above in connection with FIG. 2.

The transmission component 1104 may transmit communications, such as reference signals, control information, data communications, or a combination thereof, to the apparatus 1106. In some aspects, the communication manager 1150 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the CU described above in connection with FIG. 2. In some aspects, the transmission component 1104 may be co-located with the reception component 1102 in a transceiver.

The communication manager 1150 may receive or may cause the reception component 1102 to receive, from a distributed unit, a configuration update including a request to change an activation status of a cell of the distributed unit. The communication manager 1150 may transmit or may cause the transmission component 1104 to transmit, to the distributed unit, a configuration update acknowledgement based at least in part on transmitting the configuration update including the request to change the activation status of the cell of the distributed unit. In some aspects, the communication manager 1150 may perform one or more operations described elsewhere herein as being performed by one or more components of the communication manager 1150.

The communication manager 1150 may transmit or may cause the transmission component 1104 to transmit, to a distributed unit, a request for a change to a service associated with the distributed unit. The communication manager 1150 may receive or may cause the reception component 1102 to receive, from the distributed unit, a response message indicating a rejection of the change to the service, wherein the response message includes information identifying a cause of the rejection of the change of service. In some aspects, the communication manager 1150 may perform one or more operations described elsewhere herein as being performed by one or more components of the communication manager 1150.

The communication manager 1150 may include a controller/processor, a memory, a scheduler, a communication unit, or a combination thereof, of the CU described above in connection with FIG. 2. In some aspects, the communication manager 1150 includes a set of components, such as a service component 1108. Alternatively, the set of components may be separate and distinct from the communication manager 1150. In some aspects, one or more components of the set of components may include or may be implemented within a controller/processor, a memory, a scheduler, a communication unit, or a combination thereof, of the CU described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive, from a distributed unit, a configuration update including a request to change an activation status of a cell of the distributed unit. The transmission component 1104 may transmit, to the distributed unit, a configuration update acknowledgement based at least in part on transmitting the configuration update including the request to change the activation status of the cell of the distributed unit.

The transmission component 1104 may transmit, to a distributed unit, a request for a change to a service associated with the distributed unit. The reception component 1102 may receive, from the distributed unit, a response message indicating a rejection of the change to the service, wherein the response message includes information identifying a cause of the rejection of the change of service.

The transmission component 1104 may transmit an indication of a set of services for which the distributed unit is enabled to reject requests for changes of services. The service component 1108 may cause the apparatus 1100 to store a context for a cell after a deactivation of a cell. The service component 1108 may determine one or more services to instruct the apparatus 1106 to establish.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a distributed unit, comprising: transmitting, to a central unit of the distributed unit, a configuration update including a request to change an activation status of a cell of the distributed unit; and receiving, from the central unit, a configuration update acknowledgement based at least in part on transmitting the configuration update including the request to change the activation status of the cell of the distributed unit.
Aspect 2: The method of Aspect 1, wherein the configuration update acknowledgement includes a confirmation of the change to the activation status of the cell of the distributed unit.
Aspect 3: The method of any of Aspects 1 to 2, wherein the change to the activation status is an activation of the cell of the distributed unit or a deactivation of the cell of the distributed unit.
Aspect 4: The method of any of Aspects 1 to 3, wherein the change to the activation status is a deactivation of the cell of the distributed unit, and wherein a context of the cell is stored at the central unit based at least in part on the deactivation of the cell of the distributed unit.
Aspect 5: The method of any of Aspects 1 to 4, wherein the change to the activation status is a deactivation of the cell of the distributed unit, and further comprising: receiving, from the central unit, a request to reactivate the cell of the distributed unit.
Aspect 6: The method of Aspect 5, wherein the request to reactivate the cell of the distributed unit occurs after the deactivation of the cell of the distributed unit without an intervening cell addition for the cell of the distributed unit.
Aspect 7: A method of wireless communication performed by a distributed unit, comprising: receiving, from a central unit, a request for a change to a service associated with the distributed unit; and transmitting, to the central unit, a response message indicating a rejection of the change to the service, wherein the response message includes information identifying a cause of the rejection of the change of service.
Aspect 8: The method of Aspect 7, wherein the cause of the rejection of the change of service is a usage of an energy saving mode.
Aspect 9: The method of any of Aspects 7 to 8, wherein the response message includes at least one of: a UE context setup failure message, a UE context modification failure message, a UE context modification required message, a UE context release required message, or a combination thereof.
Aspect 10: The method of any of Aspects 7 to 9, wherein the response message includes a failure to be setup or modified list message for at least one of: a signal radio bearer, a data radio bearer, a backhaul radio link control channel, a sidelink data radio bearer, a secondary cell, or a combination thereof.
Aspect 11: The method of any of Aspects 7 to 10, wherein an indication of the cause of the rejection of the change of the service is conveyed in a cause value field associated with rejecting the change of the service.
Aspect 12: The method of any of Aspects 7 to 11, wherein the change of the service includes at least one of: a cell activation, a UE context setup, a channel setup, a channel modification, a context modification for a child of the distributed unit, or a combination thereof.
Aspect 13: The method of any of Aspects 7 to 12, wherein the distributed unit is configured to admit the service for which the change of the service is requested, and wherein the response message includes a request for a release of the service.
Aspect 14: The method of any of Aspects 7 to 13, wherein the response message includes timing information for a discontinuation or resumption of the service.
Aspect 15: The method of any of Aspects 7 to 14, further comprising: receiving an indication of a set of services for which the distributed unit is enabled to reject requests for changes of services; and wherein transmitting the response message comprises: transmitting the response message indicating the rejection of the change of service based at least in part on the service being included in the set of services for which the distributed unit is enabled to reject requests for changes of services.
Aspect 16: A method of wireless communication performed by a central unit, comprising: receiving, from a distributed unit of the central unit, a configuration update including a request to change an activation status of a cell of the distributed unit; and transmitting, to the distributed unit, a configuration update acknowledgement based at least in part on transmitting the configuration update including the request to change the activation status of the cell of the distributed unit.
Aspect 17: The method of Aspect 16, wherein the configuration update acknowledgement includes a confirmation of the change to the activation status of the cell of the distributed unit.
Aspect 18: The method of any of Aspects 16 to 17, wherein the change to the activation status is an activation of the cell of the distributed unit or a deactivation of the cell of the distributed unit.
Aspect 19: The method of any of Aspects 16 to 18, wherein the change to the activation status is a deactivation of the cell of the distributed unit, and wherein a context of the cell is stored at the central unit based at least in part on the deactivation of the cell of the distributed unit.
Aspect 20: The method of any of Aspects 16 to 19, wherein the change to the activation status is a deactivation of the cell of the distributed unit, and further comprising: transmitting, to the distributed unit, a request to reactivate the cell of the distributed unit.
Aspect 21: The method of Aspect 20, wherein the request to reactivate the cell of the distributed unit occurs after the deactivation of the cell of the distributed unit without an intervening cell addition for the cell of the distributed unit.
Aspect 22: A method of wireless communication performed by a central unit, comprising: transmitting, to a distributed unit, a request for a change to a service associated with the distributed unit; and receiving, from the distributed unit, a response message indicating a rejection of the change to the service, wherein the response message includes information identifying a cause of the rejection of the change of service.
Aspect 23: The method of Aspect 22, wherein the cause of the rejection of the change of service is a usage of an energy saving mode.
Aspect 24: The method of any of Aspects 22 to 23, wherein the response message includes at least one of: a UE context setup failure message, a UE context modification failure message, a UE context modification required message, a UE context release required message, or a combination thereof.
Aspect 25: The method of any of Aspects 22 to 24, wherein the response message includes a failure to be setup or modified list message for at least one of: a signal radio bearer, a data radio bearer, a backhaul radio link control channel, a sidelink data radio bearer, a secondary cell, or a combination thereof.
Aspect 26: The method of any of Aspects 22 to 25, wherein an indication of the cause of the rejection of the change of the service is conveyed in a cause value field associated with rejecting the change of the service.
Aspect 27: The method of any of Aspects 22 to 26, wherein the change of the service includes at least one of: a cell activation, a UE context setup, a channel setup, a channel modification, a context modification for a child of the distributed unit, or a combination thereof
Aspect 28: The method of any of Aspects 22 to 27, wherein the response message includes a request for a release of the service, and further comprising: transmitting an instruction to release the service based at least in part on receiving the response message.
Aspect 29: The method of any of Aspects 22 to 28, wherein the response message includes timing information for a discontinuation or resumption of the service.
Aspect 30: The method of any of Aspects 22 to 29, further comprising: transmitting an indication of a set of services for which the distributed unit is enabled to reject requests for changes of services; and wherein receiving the response message comprises: receiving the response message indicating the rejection of the change of service based at least in part on the service being included in the set of services for which the distributed unit is enabled to reject requests for changes of services.
Aspect 31: An apparatus for wireless communication at a device, comprising a processor; memory coupled with the processor; and instructions stored in the memory and executable by the processor to cause the apparatus to perform the method of one or more of Aspects 1-6.
Aspect 32: A device for wireless communication, comprising a memory and one or more processors coupled to the memory, the one or more processors configured to perform the method of one or more of Aspects 1-6.
Aspect 33: An apparatus for wireless communication, comprising at least one means for performing the method of one or more of Aspects 1-6.
Aspect 34: A non-transitory computer-readable medium storing code for wireless communication, the code comprising instructions executable by a processor to perform the method of one or more of Aspects 1-6.
Aspect 35: A non-transitory computer-readable medium storing a set of instructions for wireless communication, the set of instructions comprising one or more instructions that, when executed by one or more processors of a device, cause the device to perform the method of one or more of Aspects 1-6.
Aspect 36: An apparatus for wireless communication at a device, comprising a processor; memory coupled with the processor; and instructions stored in the memory and executable by the processor to cause the apparatus to perform the method of one or more of Aspects 7-15.
Aspect 37: A device for wireless communication, comprising a memory and one or more processors coupled to the memory, the one or more processors configured to perform the method of one or more of Aspects 7-15.
Aspect 38: An apparatus for wireless communication, comprising at least one means for performing the method of one or more of Aspects 7-15.
Aspect 39: A non-transitory computer-readable medium storing code for wireless communication, the code comprising instructions executable by a processor to perform the method of one or more of Aspects 7-15.
Aspect 40: A non-transitory computer-readable medium storing a set of instructions for wireless communication, the set of instructions comprising one or more instructions that, when executed by one or more processors of a device, cause the device to perform the method of one or more of Aspects 7-15.
Aspect 41: An apparatus for wireless communication at a device, comprising a processor; memory coupled with the processor; and instructions stored in the memory and executable by the processor to cause the apparatus to perform the method of one or more of Aspects 16-21.
Aspect 42: A device for wireless communication, comprising a memory and one or more processors coupled to the memory, the one or more processors configured to perform the method of one or more of Aspects 16-21.
Aspect 43: An apparatus for wireless communication, comprising at least one means for performing the method of one or more of Aspects 16-21.
Aspect 44: A non-transitory computer-readable medium storing code for wireless communication, the code comprising instructions executable by a processor to perform the method of one or more of Aspects 16-21.
Aspect 45: A non-transitory computer-readable medium storing a set of instructions for wireless communication, the set of instructions comprising one or more instructions that, when executed by one or more processors of a device, cause the device to perform the method of one or more of Aspects 16-21.
Aspect 46: An apparatus for wireless communication at a device, comprising a processor; memory coupled with the processor; and instructions stored in the memory and executable by the processor to cause the apparatus to perform the method of one or more of Aspects 22-30.
Aspect 47: A device for wireless communication, comprising a memory and one or more processors coupled to the memory, the one or more processors configured to perform the method of one or more of Aspects 22-30.
Aspect 48: An apparatus for wireless communication, comprising at least one means for performing the method of one or more of Aspects 22-30.
Aspect 49: A non-transitory computer-readable medium storing code for wireless communication, the code comprising instructions executable by a processor to perform the method of one or more of Aspects 22-30.
Aspect 50: A non-transitory computer-readable medium storing a set of instructions for wireless communication, the set of instructions comprising one or more instructions that, when executed by one or more processors of a device, cause the device to perform the method of one or more of Aspects 22-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A distributed unit for wireless communication, comprising:
at least one processor; and
at least one memory communicatively coupled with the at least one processor and storing processor-readable code that, when executed by the at least one processor, is configured to cause the distributed unit to:
transmit, to a central unit of the distributed unit, a configuration update including a request to change an activation status of a cell of the distributed unit; and
receive, from the central unit, a configuration update acknowledgement based at least in part on transmitting the configuration update including the request to change the activation status of the cell of the distributed unit.

2. The distributed unit of claim 1, wherein the configuration update acknowledgement includes a confirmation of the change to the activation status of the cell of the distributed unit.

3. The distributed unit of claim 1, wherein the change to the activation status is an activation of the cell of the distributed unit or a deactivation of the cell of the distributed unit.

4. The distributed unit of claim 1, wherein the change to the activation status is a deactivation of the cell of the distributed unit, and
wherein a context of the cell is stored at the central unit based at least in part on the deactivation of the cell of the distributed unit.

5. The distributed unit of claim 1, wherein the change to the activation status is a deactivation of the cell of the distributed unit, and
wherein the processor-readable code, when executed by the at least one processor, is configured to cause the distributed unit to:
receive, from the central unit, a request to reactivate the cell of the distributed unit.

6. The distributed unit of claim 5, wherein the request to reactivate the cell of the distributed unit occurs after the deactivation of the cell of the distributed unit without an intervening cell addition for the cell of the distributed unit.

7. A distributed unit for wireless communication, comprising:
at least one processor; and
at least one memory communicatively coupled with the at least one processor and storing processor-readable code that, when executed by the at least one processor, is configured to cause the distributed unit to:
receive, from a central unit, a request for a change to a service associated with the distributed unit; and
transmit, to the central unit, a response message indicating a rejection of the change to the service, wherein the response message includes information identifying a cause of the rejection of the change of service.

8. The distributed unit of claim 7, wherein the cause of the rejection of the change of service is a usage of an energy saving mode.

9. The distributed unit of claim 7, wherein the response message includes at least one of:
a UE context setup failure message,
a UE context modification failure message,
a UE context modification required message,
a UE context release required message, or
a combination thereof.

10. The distributed unit of claim 7, wherein the response message includes a failure to be setup or modified list message for at least one of:
a signal radio bearer,
a data radio bearer,
a backhaul radio link control channel,
a sidelink data radio bearer,
a secondary cell, or
a combination thereof.

11. The distributed unit of claim 7, wherein an indication of the cause of the rejection of the change of the service is conveyed in a cause value field associated with rejecting the change of the service.

12. The distributed unit of claim 7, wherein the change of the service includes at least one of:
a cell activation,
a UE context setup,
a channel setup,
a channel modification,
a context modification for a child of the distributed unit, or
a combination thereof.

13. The distributed unit of claim 7, wherein the distributed unit is configured to admit the service for which the change of the service is requested, and
wherein the response message includes a request for a release of the service.

14. The distributed unit of claim 7, wherein the response message includes timing information for a discontinuation or resumption of the service.

15. The distributed unit of claim 7, wherein the at least one memory stores processor-readable code configured to cause the distributed unit to:
receive an indication of a set of services for which the distributed unit is enabled to reject requests for changes of services; and
wherein, to cause the distributed unit to transmit the response message, the processor-readable code, when executed by the at least one processor, is configured to cause the distributed unit to:
transmit the response message indicating the rejection of the change of service based at least in part on the service being included in the set of services for which the distributed unit is enabled to reject requests for changes of services.

16. A central unit for wireless communication, comprising:
at least one processor; and
at least one memory communicatively coupled with the at least one processor and storing processor-readable code that, when executed by the at least one processor, is configured to cause the central unit to:
receive, from a distributed unit of the central unit, a configuration update including a request to change an activation status of a cell of the distributed unit; and
transmit, to the distributed unit, a configuration update acknowledgement based at least in part on transmitting the configuration update including the request to change the activation status of the cell of the distributed unit.

17. The central unit of claim 16, wherein the configuration update acknowledgement includes a confirmation of the change to the activation status of the cell of the distributed unit.

18. The central unit of claim 16, wherein the change to the activation status is an activation of the cell of the distributed unit or a deactivation of the cell of the distributed unit.

19. The central unit of claim 16, wherein the change to the activation status is a deactivation of the cell of the distributed unit, and
wherein a context of the cell is stored at the central unit based at least in part on the deactivation of the cell of the distributed unit.

20. The central unit of claim 16, wherein the change to the activation status is a deactivation of the cell of the distributed unit, and
wherein the processor-readable code, when executed by the at least one processor, is configured to cause the central unit to:
transmit, to the distributed unit, a request to reactivate the cell of the distributed unit.

21. The central unit of claim 20, wherein the request to reactivate the cell of the distributed unit occurs after the deactivation of the cell of the distributed unit without an intervening cell addition for the cell of the distributed unit.

22. A central unit for wireless communication, comprising:
at least one processor; and
at least one memory communicatively coupled with the at least one processor and storing processor-readable code that, when executed by the at least one processor, is configured to cause the central unit to:
transmit, to a distributed unit, a request for a change to a service associated with the distributed unit; and
receive, from the distributed unit, a response message indicating a rejection of the change to the service, wherein the response message includes information identifying a cause of the rejection of the change of service.

23. The central unit of claim 22, wherein the cause of the rejection of the change of service is a usage of an energy saving mode.

24. The central unit of claim 22, wherein the response message includes at least one of:
a UE context setup failure message,
a UE context modification failure message,
a UE context modification required message,
a UE context release required message, or
a combination thereof.

25. The central unit of claim 22, wherein the response message includes a failure to be setup or modified list message for at least one of:
a signal radio bearer,
a data radio bearer,
a backhaul radio link control channel,
a sidelink data radio bearer,
a secondary cell, or
a combination thereof.

26. The central unit of claim 22, wherein an indication of the cause of the rejection of the change of the service is conveyed in a cause value field associated with rejecting the change of the service.

27. The central unit of claim 22, wherein the change of the service includes at least one of:
a cell activation,
a UE context setup,
a channel setup,
a channel modification,
a context modification for a child of the distributed unit, or
a combination thereof.

28. The central unit of claim 22, wherein the response message includes a request for a release of the service, and
wherein the processor-readable code, when executed by the at least one processor, is configured to cause the central unit to:
transmit an instruction to release the service based at least in part on receiving the response message.

29. The central unit of claim 22, wherein the response message includes timing information for a discontinuation or resumption of the service.

30. The central unit of claim 22, wherein the at least one memory stores processor-readable code configured to cause the central unit to:
transmit an indication of a set of services for which the distributed unit is enabled to reject requests for changes of services; and
wherein, to cause the central unit to receive the response message, the processor-readable code, when executed by the at least one processor, is configured to cause the central unit to:
receive the response message indicating the rejection of the change of service based at least in part on the service being included in the set of services for which the distributed unit is enabled to reject requests for changes of services.
